(19) United States
(12) Patent Application Publication
(10) Pub. No.: US 2021/0101153 A1
(43) Pub. Date: Apr. 8, 2021

(54) PRETREATMENT DEVICE FOR MALDI

(71) Applicant: SHIMADZU CORPORATION, Kyoto-shi (JP)

(72) Inventors: Kenta TERASHIMA, Kyoto-shi (JP); Kazuteru TAKAHASHI, Kyoto-shi (JP)

(73) Assignee: SHIMADZU CORPORATION, Kyoto-shi (JP)

(21) Appl. No.: 16/990,081

(22) Filed: Aug. 11, 2020

(30) Foreign Application Priority Data
Oct. 4, 2019 (JP) 2019-183755

(51) Int. Cl. B01L 3/00; G01N 1/38; H01J 49/16; G01N 27/62

(52) U.S. Cl. CPC B01L 3/523; G01N 1/38; H01J 49/164; G01N 27/628; B01L 2200/0684; B01L 2200/16; B01L 2300/042; B01L 2300/14; G01N 2001/386

(57) ABSTRACT

A first container for housing a reagent and a second container for housing the first container inside are provided. The pressurization mechanism pressurizes a pressurization space formed outside the first container in the second container to pressurize the inside of the first container communicating with the pressurization space. The reagent is drawn out from the pressurized inside of the first container through a pipe.

### CROSS REFERENCE TO RELATED APPLICATION

This application claims priority to Japanese Patent Application No. 2019-183755 filed on Oct. 4, 2019, the entire disclosure of which is incorporated by reference herein.

### BACKGROUND OF THE INVENTION

### Field of the Invention

The present invention relates to a pretreatment device for MALDI.

### Description of the Related Art

Matrix assisted laser desorption/ionization (MALDI) is known as an example of a method of ionizing a sample. When performing analysis using MALDI, as a pretreatment for the sample, a matrix substance that easily absorbs laser light and is easily ionized is premixed with the sample.

In a general pretreatment, a solution containing a matrix substance (matrix solution) is added as a reagent to a sample, and a measurement target substance contained in the sample is taken into the matrix solution. Then, a solvent in the matrix solution is vaporized by drying, and crystal grains containing the measurement target substance are formed. By irradiating the crystal grains with laser light, the measurement target substance can be ionized by the interaction among the measurement target substance, the matrix substance, and the laser light.

As a method of adding a reagent such as a matrix solution to a sample, a spray method capable of forming fine crystals is known. In the spray methods disclosed in WO2019/106799 and WO2019/106800, a liquid level of the matrix solution in a container is pressurized by introducing an inert gas into the container in which the matrix solution is housed. As a result, the matrix solution is drawn out from a pipe communicating with the inside of the container, and the matrix solution is sprayed from a nozzle through a resistance pipe.

The matrix solution is sprayed toward a sample plate on which the sample is placed. The sample plate is installed on a stage, and the matrix solution can be applied to the entire application area on the sample plate by moving the stage while spraying the matrix solution.

### SUMMARY OF THE INVENTION

The amount of the matrix solution applied onto the sample plate is extremely small. Therefore, it is conceivable to downsize the container for housing the matrix solution. However, in the container for housing the matrix solution, it is necessary to install various kinds of mechanical structural components such as a gas pipe for pressurizing the inside of the container, a pipe for drawing out the matrix solution in the container, and a fixing member for fixing these pipes. In order to install such components in the container, since the container needs to have a certain volume or more, there is a limit to downsizing the container.

Further, since gas is rapidly introduced into the container to pressurize the liquid level of the matrix solution, the matrix solution scatters in the container and adheres to the inner surface of the container. In a case where the container cannot be downsized, it is difficult to dispose the container in consideration of the cost of the container. Therefore, it is necessary to wash the container every time and house the matrix solution again in the container, but in some cases, the matrix solution adhering to the inside of the container (especially mechanical structural components) may not be completely removed. In such a case, the mixing of the previously used matrix solution may adversely affect the pretreatment.

The invention has been made in view of the above circumstances, and an object of the invention is to provide a pretreatment device for MALDI capable of downsizing a container for housing a reagent.

A first aspect of the invention is a pretreatment device for MALDI which performs a pretreatment using a reagent for MALDI and includes a first container, a second container, a pressurization mechanism, and a reagent drawing-out pipe. The first container houses the reagent. The second container houses the first container inside. The pressurization mechanism pressurizes a pressurization space formed outside the first container in the second container to pressurize an inside of the first container communicating with the pressurization space. The reagent drawing-out pipe is for drawing out the reagent from the pressurized inside of the first container.

According to the first aspect of the invention, the outside of the first container for housing the reagent is covered with the second container, and the pressurization space formed outside the first container in the second container is pressurized so that the reagent in the first container can be drawn out. Therefore, it is possible to downsize the first container as a container for housing the reagent.

### BRIEF DESCRIPTION OF THE DRAWINGS

FIG. 1 is a schematic diagram illustrating an embodiment of a pretreatment device for MALDI;

FIG. 2 is a schematic sectional view illustrating a specific configuration of a reagent storage section;

FIG. 3 is a plan view illustrating a configuration example of a stopper;

FIG. 4 is a sectional view illustrating a state in which a stopper is attached to a pipe; and

FIG. 5 is a schematic sectional view illustrating a modification of a first container.

### DETAILED DESCRIPTION OF THE PREFERRED EMBODIMENTS

### 1. Overall Configuration of Pretreatment Device for MALDI

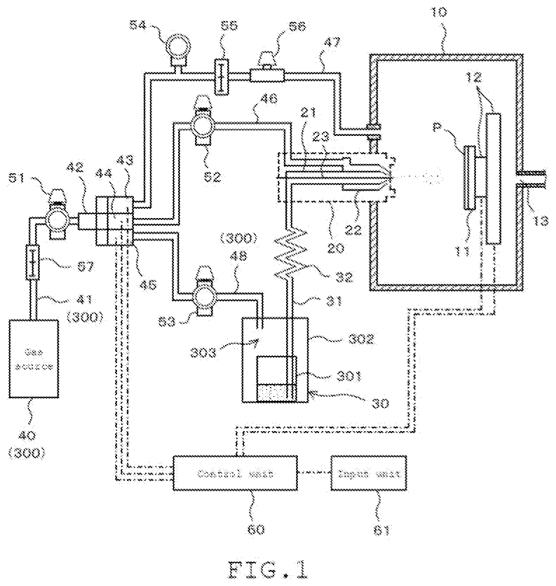

FIG. 1 is a schematic diagram illustrating an embodiment of a pretreatment device for MALDI. The pretreatment device for MALDI is a device for performing a pretreatment using a reagent for MALDI. In the embodiment, a configuration will be described in which a solution containing a matrix substance (matrix solution) is used as an example of the reagent for MALDI and the matrix solution is sprayed toward a sample plate P by a spray method. However, the reagent for MALDI is not limited to the matrix solution, and may be another reagent such as a derivatization reagent or an enzyme digestion reagent.

A sample (not illustrated) such as a biological tissue section is placed on the sample plate P. The sample plate P on which the sample is placed is installed in a hollow chamber 10, and the matrix solution sprayed from a nozzle 20 into the chamber 10 is applied onto the sample plate P in the chamber 10. The nozzle 20 faces the sample plate P, and sprays the matrix solution in a direction orthogonal to the sample plate P.

Inside the chamber 10, a stage 11 to which the sample plate P can be attached and detached is provided. The stage 11 can be moved by a moving mechanism 12. The moving mechanism 12 can move the sample plate P in two directions (X direction and Y direction) orthogonal to each other in a plane parallel to the sample plate P. Therefore, by moving the sample plate P in the X direction and the Y direction by using the moving mechanism 12 while spraying the matrix solution from the fixed nozzle 20, a spot (spray spot) on the sample plate P onto which the matrix solution is sprayed can be moved. However, the moving mechanism 12 is not limited to the configuration of moving the sample plate P, and may have a configuration of moving the nozzle 20 in parallel to the sample plate P, or a configuration of moving both the sample plate P and the nozzle 20.

An exhaust port 13 is formed on a wall surface of the chamber 10. The exhaust port 13 communicates with a draft chamber (not illustrated) so that the gas in the chamber 10 is exhausted to the draft chamber.

The nozzle 20 includes a liquid feed pipe 21 and a gas pipe 22. The liquid feed pipe 21 is for ejecting the matrix solution into the chamber 10, and the inner diameter of a tip end portion is small, for example, about 0.4 mm. The gas pipe 22 is for ejecting gas into the chamber 10, and has a larger diameter than that of the liquid feed pipe 21. The gas pipe 22 is disposed coaxially with the liquid feed pipe 21 so as to surround the outside of the liquid feed pipe 21. As a result, a gas flow path is formed between an inner peripheral surface of the gas pipe 22 and an outer peripheral surface of the liquid feed pipe 21.

The tip end positions of the liquid feed pipe 21 and the gas pipe 22 are substantially coincident with each other in an axial direction. A needle 23 is provided in the liquid feed pipe 21 along its axis. The tip end of the needle 23 protrudes from the tip end of the liquid feed pipe 21. The matrix solution fed in the liquid feed pipe 21 is guided along the needle 23, and is ejected from the tip end of the needle 23 into the chamber 10. At this time, the matrix solution is diffused by the gas ejected from the gas pipe 22 so that the atomized matrix solution is sprayed into the chamber 10.

The liquid feed pipe 21 communicates with a reagent storage section 30 via a pipe 31. The reagent storage section 30 includes a first container 301 and a second container 302. The first container 301 is for housing a reagent, and houses the matrix solution in the embodiment. The amount of the matrix solution housed in the first container 301 is small, for example, about 2 to 10 mL. One end of the pipe 31 is located inside the first container 301. The second container 302 houses the first container 301 inside.

The matrix solution in the first container 301 is guided to the nozzle 20 via the pipe 31, and is sprayed from the liquid feed pipe 21 of the nozzle 20 into the chamber 10. A resistance pipe 32 is provided in the middle of the pipe 31. The inner diameter of the resistance pipe 32 is smaller than the inner diameter of the pipe 31, and is, for example, about 0.013 mm. Therefore, the matrix solution fed from the inside of the first container 301 to the pipe 31 is stably supplied to the nozzle 20 at an appropriate flow rate by receiving resistance in the resistance pipe 32. However, the resistance pipe 32 is not limited to a configuration having a diameter smaller than that of the pipe 31, and another configuration capable of providing resistance to the matrix solution such as a configuration in which a resistor is provided inside may be adopted.

The gas pipe 22 communicates with a gas source 40 via pipes 41 and 46. The gas source 40 includes, for example, a gas cylinder or a gas generator, and delivers a gas having a pressure higher than atmospheric pressure to the pipe 41. The gas delivered from the gas source 40 is, for example, an inert gas such as nitrogen gas. The pipe 41 communicates with the pipe 46 via a manifold 42 and a switching valve 44. The manifold 42 is a multi-branch pipe for branching the gas delivered from the gas source 40 to the pipe 41 into a plurality of (three in this example) branch paths, and the switching valve 44 is provided in one of the branch paths. The supply and stop of gas from the pipe 41 to the pipe 46 can be switched by the switching valve 44.

The pipe 41 is provided with an adjustment valve 51 and a flow meter 57. By adjusting opening degree of the adjustment valve 51 based on the flow rate of the gas in the pipe 41 detected by the flow meter 57, the gas can be delivered from the gas source 40 to the pipe 41 at a desired flow rate. The pipe 46 is provided with an adjustment valve 52, and the flow rate of the gas supplied to the nozzle 20 can be adjusted by adjusting the opening degree of the adjustment valve 52.

In addition to the switching valve 44, switching valves 43 and 45 are provided in the respective branch paths branched by the manifold 42. A pipe 47 communicates with the switching valve 43, and a pipe 48 communicates with the switching valve 45. The supply and stop of gas from the pipe 41 to the pipe 47 can be switched by the switching valve 43. Further, the supply and stop of gas from the pipe 41 to the pipe 48 can be switched by the switching valve 45.

The pipe 47 communicates with the inside of the chamber 10. By supplying gas into the chamber 10 via the pipes 41 and 47 before spraying the matrix solution from the nozzle 20, the air in the chamber 10 can be replaced with the gas from the gas source 40. The pipe 47 is provided with a pressure gauge 54, a flow meter 55, an adjustment valve 56, and the like. By adjusting the opening degree of the adjustment valve 56 based on the pressure of the gas in the pipe 47 detected by the pressure gauge 54 and the flow rate of the gas in the pipe 47 detected by the flow meter 55, the gas can be supplied to the chamber 10 at the desired pressure and flow rate.

The pipe 48 communicates with the reagent storage section 30. Specifically, one end of the pipe 48 is located inside the second container 302 in the reagent storage section 30 and outside the first container 301. The inner diameter of the tip end of the pipe 48 is, for example, 4 mm or more. A pressurization space 303 is formed outside the first container 301 in the second container 302. By supplying gas into the pressurization space 303 via the pipes 41 and 48 to pressurize the pressurization space 303, the inside of the first container 301 communicating with the pressurization space 303 can be pressurized. At this time, the pressure inside the first container 301 is, for example, 0.1 MPa or more. As a result, the matrix solution is drawn out from the pressurized first container 301 to the pipe 31.

As described above, the gas source 40, the pipes 41 and 48, and the like constitute a pressurization mechanism 300 for pressurizing the pressurization space 303. In addition, the pipe 31 constitutes a reagent drawing-out pipe for drawing out the reagent from the first container 301. The pipe 48 is provided with an adjustment valve 53, and the flow rate of the gas supplied to the pressurization space 303 can be adjusted by adjusting the opening degree of the adjustment valve 53.

Each unit such as the moving mechanism 12 and the switching valves 43, 44, and 45 is electrically connected to a control unit 60. The control unit 60 includes, for example, a central processing unit (CPU), and the CPU executes a computer program to control the operation of each unit. An input unit 61 including, for example, a keyboard or a mouse is electrically connected to the control unit 60. A user can input various settings by operating the input unit 61.

### 2. Specific Configuration of Reagent Storage Section

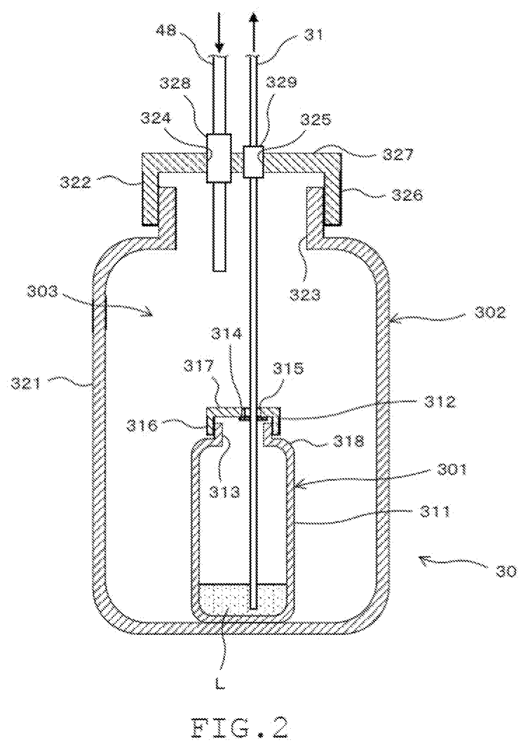

FIG. 2 is a schematic sectional view illustrating a specific configuration of the reagent storage section 30. The first container 301 and the second container 302 included in the reagent storage section 30 have different volumes. Specifically, the second container 302 has a larger volume than that of the first container 301, and the first container 301 can be put in and taken out from the inside of the second container 302.

The first container 301 includes a container body 311 and a lid member (first lid member) 312. The container body 311 is formed in a bottomed cylindrical shape having an opening (first opening) 313 at the upper end portion, for example. The lid member 312 can be attached to and detached from the upper end portion of the container body 311, and can cover the opening 313 in a state of being attached to the container body 311. That is, the opening 313 can be opened or closed by attaching or detaching the lid member 312 to or from the container body 311.

In this example, the lid member 312 is screwed into the upper end portion of the container body 311, so that the lid member 312 is attached to the container body 311. However, the lid member 312 is not limited to the screw-in type, and the lid member 312 may be attached to the container body 311 by, for example, a fitting type, or the lid member 312 may be simply placed on the opening 313 to cover the opening 313.

The material of the container body 311 is not particularly limited, but is made of, for example, glass or resin. After a matrix solution L is injected into the container body 311 through the opening 313, the lid member 312 is attached to the container body 311. The container body 311 is transparent or translucent, and the amount of the matrix solution L in the container body 311 can be checked from the outside. However, only a part of the container body 311 may be transparent or translucent, or the whole of the container body 311 may be opaque.

The second container 302 includes a container body 321 and a lid member (second lid member) 322. The container body 321 is formed in a bottomed cylindrical shape having an opening (second opening) 323 at the upper end portion, for example. The lid member 322 can be attached to and detached from the upper end portion of the container body 321, and can cover the opening 323 in a state of being attached to the container body 321. That is, the opening 323 can be opened or closed by attaching or detaching the lid member 322 to or from the container body 321.

In this example, the lid member 322 is screwed into the upper end portion of the container body 321, so that the lid member 322 is attached to the container body 321. A packing (not illustrated) is attached to at least one of the container body 321 and the lid member 322. Accordingly, when the lid member 322 is attached to the container body 321, the opening 323 is sealed, and the inside of the container body 321 becomes in an airtight state. However, the lid member 322 is not limited to the screw-in type, and the lid member 322 may be attached to the container body 321 by, for example, a fitting type.

The material of the container body 321 is not particularly limited, but is made of, for example, glass or resin. The inner diameter of the opening 323 in the container body 321 of the second container 302 is larger than the outer diameter of the container body 311 of the first container 301. Therefore, the first container 301 can be inserted into the second container 302 through the opening 323. After the first container 301 is inserted into the container body 321 through the opening 323, the lid member 322 is attached to the container body 321. The container body 321 is transparent or translucent, and the amount of the matrix solution L in the first container 301 housed in the container body 321 can be checked from the outside. However, only a part of the container body 321 may be transparent or translucent, or the whole of the container body 321 may be opaque.

In the lid member 322, a gas inlet 324 and an insertion hole (second insertion hole) 325 are formed. Specifically, the lid member 322 has a configuration in which an annular peripheral wall 326 that is attached to and detached from the container body 321, and an end wall 327 that closes one end (upper end) of the peripheral wall are integrally formed. The gas inlet 324 and the insertion hole 325 are formed side by side on the end wall 327.

One end portion of the pipe 48 is inserted through the gas inlet 324. Specifically, a fixing member 328 is fixed to the gas inlet 324, and the fixing member 328 is fixed in a state where the pipe 48 is inserted through the fixing member 328. The fixing member 328 is fixed to the gas inlet 324 via a packing (not illustrated) to close the gas inlet 324 in an airtight state. As a result, the gas can be introduced into the pressurization space 303 through the pipe 48 inserted through the gas inlet 324. In this example, one end of the pipe 48 is located in the pressurization space 303, but is not limited to such a configuration, one end of the pipe 48 may be located in the gas inlet 324 or outside the gas inlet 324, and the gas supplied from the pipe 48 may be introduced into the pressurization space 303 through the gas inlet 324.

One end of the pipe 31 as the reagent drawing-out pipe is inserted through the insertion hole 325. Specifically, a fixing member 329 is fixed to the insertion hole 325, and the fixing member 329 is fixed in a state where the pipe 31 is inserted through the fixing member 329. The fixing member 329 is fixed to the insertion hole 325 via a packing (not illustrated) to close the insertion hole 325 in an airtight state.

In the lid member 312 of the first container 301, an insertion hole (first insertion hole) 315 is formed. Specifically, the lid member 312 has a configuration in which an annular peripheral wall 316 that is attached to and detached from the container body 311, and an end wall 317 that closes one end (upper end) of the peripheral wall are integrally formed. The insertion hole 315 is formed in the end wall 317.

The tip end portion of the pipe 31 as the reagent drawing-out pipe inserted into the container body 321 of the second container 302 is inserted through the insertion hole 315. Specifically, the inner diameter of the insertion hole 315 is formed larger than the outer diameter of the tip end portion of the pipe 31. As a result, the tip end portion of the pipe 31 is inserted into the insertion hole 315 so as to be slidable along the axial direction.

Since a gap is formed between the inner peripheral surface of the insertion hole 315 and the outer peripheral surface of the pipe 31, the gas in the pressurization space 303 can be introduced into the container body 311 of the first container 301 through the gap. Therefore, by pressurizing the pressurization space 303, the inside of container body 311 of the first container 301 communicating with the pressurization space 303 through the insertion hole 315 can be pressurized so that the matrix solution L in the container body 311 can be drawn out to the pipe 31.

The first container 301 has a simple structure having the insertion hole 315, and is not provided with a mechanical structural component such as a fixing member for fixing the pipe. Therefore, the first container 301 is cheaper than the second container 302 and can be used as a disposable item. As a result, the time and effort for cleaning the first container 301 for reuse can be reduced.

A stopper 314 is attached to a portion of the pipe 31 inserted into the first container 301. The stopper 314 is for preventing the pipe 31 from coming off from the insertion hole 315. By attaching the stopper 314 to an appropriate position of the pipe 31, the tip end position of the pipe 31 can be reliably disposed at a position lower than the liquid level of the matrix solution L.

Further, when the pipe 31 is pulled upward, the stopper 314 comes into contact with the end wall 317 of the lid member 312. That is, the stopper 314 is formed such that the outer diameter of at least a part of the stopper 314 is larger than the inner diameter of the insertion hole 315, and when the pipe 31 is pulled upward, the stopper 314 is caught on a peripheral portion of the insertion hole 315. Therefore, if the pipe 31 is pulled upward in a state where the lid member 312 is attached to the container body 311, the entire first container 301 can be lifted. Then, when the pipe 31 is pulled upward as it is, the first container 301 can be taken out of the second container 302 through the opening 323 in the container body 321 of the second container 302.

In the embodiment, the outer diameter of the upper end portion of the container body 311 of the first container 301 is smaller than the outer diameters of the other portions. That is, the first container 301 has a shape in which the upper end portion is narrowed. The outer peripheral surface of the first container 301 has a curved surface 318 that is smoothly convexly curved toward the upper end portion. Therefore, when the pipe 31 is pulled upward and the first container 301 is taken out of the second container 302, the curved surface 318 comes into contact with the peripheral portion of the opening 323 of the second container 302, and the first container 301 can be taken out smoothly along the curved surface 318.

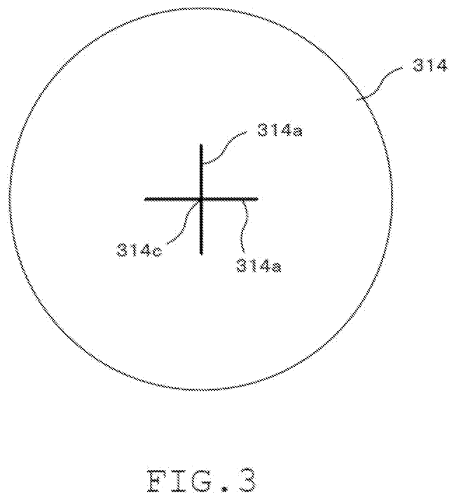

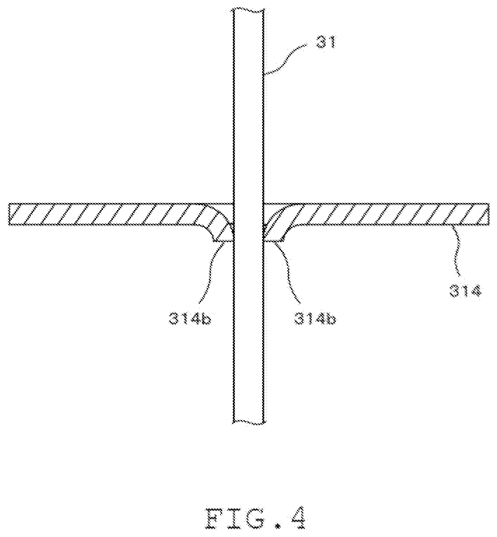

FIG. 3 is a plan view illustrating a configuration example of the stopper 314. FIG. 4 is a sectional view illustrating a state in which the stopper 314 is attached to the pipe 31. The material and shape of the stopper 314 are not particularly limited, but in this example, the stopper 314 is formed in a thin plate shape made of polytetrafluoroethylene (PTFE). However, the stopper 314 may be made of another material such as metal. Further, the outer shape of the stopper 314 is not limited to a circular shape, and may be any shape such as a rectangular shape or a C shape.

In the stopper 314, for example, a plurality of (for example, two) slits 314a intersecting with each other are formed. As a result, a plurality of (for example, four) holding pieces 314b separated by the slits 314a are formed in an elastically deformable state. When the pipe 31 is inserted into a position 314c where the plurality of slits 314a intersect each other, a force is applied from the pipe 31 to the tip end of each holding piece 314b, and each holding piece 314b is elastically deformed. As a result, the pipe 31 penetrates the stopper 314 while being elastically sandwiched by the tip ends of the holding pieces 314b.

In a case of attaching the stopper 314 to the pipe 31, the pipe 31 is inserted into the insertion hole 315 formed in the lid member 312 of the first container 301, and the stopper 314 is attached to the tip end side of the inserted pipe 31. The position of the stopper 314 with respect to the pipe 31 is adjusted such that the tip end of the pipe 31 is located at the bottom of the container body 311 when the lid member 312 is attached to the container body 311. The stopper 314 attached to the pipe 31 is fixed so as not to easily slide with respect to the pipe 31 by the resistance received from each holding piece 314b.

### 3. Modification of First Container

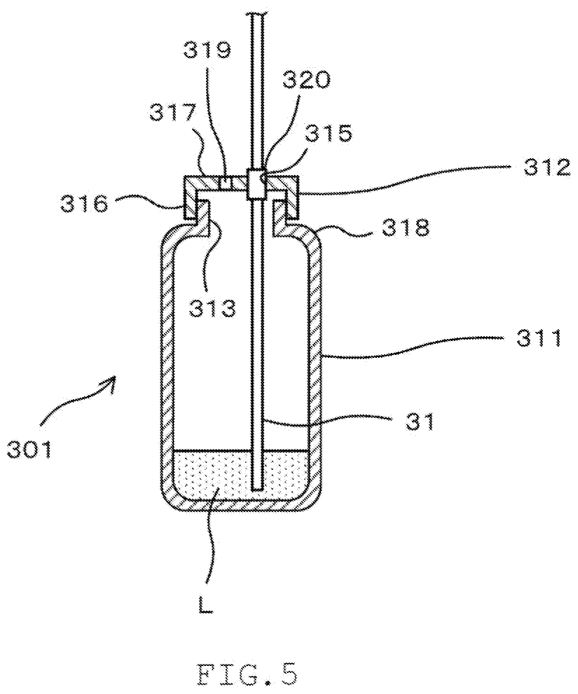

FIG. 5 is a schematic sectional view illustrating a modification of the first container 301. In the following, the same reference numerals are given to the configurations similar to those in the above-described embodiment in the drawings, and detailed description thereof will be omitted.

In the above-described embodiment, the configuration in which the gas in the pressurization space 303 is introduced into the container body 311 through the gap formed between the insertion hole 315 of the lid member 312 and the pipe 31 has been described. On the other hand, in the modification, a vent hole 319 for causing the pressurization space 303 to communicate with the inside of the first container 301 (inside of the container body 311) is formed in the lid member 312 separately from the insertion hole 315. As a result, the gas in the pressurization space 303 can be introduced into the container body 311 through the vent hole 319.

The vent hole 319 is formed in the end wall 317 of the lid member 312. The inner diameter of the vent hole 319 is not particularly limited, but may be any value as long as the gas in the pressurization space 303 can be smoothly introduced into the container body 311. A fixing member 320 may be fixed to the insertion hole 315 of the lid member 312, and the fixing member 320 may be fixed in a state where the pipe 31 is inserted through the fixing member 320. In this case, the fixing member 320 functions as a stopper. The vent hole 319 may be formed in the container body 311 instead of the lid member 312.

### 4. Other Modifications

The first container 301 is not limited to the configuration including the lid member 312 that can be attached to and detached from the container body 311, and the lid member 312 may be fixed to the container body 311 so as to be openable and closable. Further, a configuration may be adopted in which the first container 301 does not include the lid member 312, the matrix solution is injected into the container body 311 from one or a plurality of openings formed in the container body 311, and the pipe 31 can be inserted into the container body 311. Similarly, the second container 302 is not limited to the configuration including the lid member 322 that can be attached to and detached from the container body 321, and the lid member 322 may be fixed to the container body 321 so as to be openable and closable.

### 5. ASPECTS

It will be appreciated by those of skill in the art that the exemplary embodiments described above are specific examples of the following aspects.

(Aspect 1) A pretreatment device for MALDI according to an aspect may be a pretreatment device for MALDI which performs a pretreatment using a reagent for MALDI, and includes

a first container that houses the reagent;

a second container that houses the first container inside;

a pressurization mechanism that pressurizes a pressurization space formed outside the first container in the second container to pressurize an inside of the first container communicating with the pressurization space; and

a reagent drawing-out pipe that draws out the reagent from the pressurized inside of the first container.

According to the pretreatment device for MALDI described in Aspect 1, the outside of the first container for housing the reagent is covered with the second container, and the pressurization space formed outside the first container in the second container is pressurized so that the reagent in the first container can be drawn out. Therefore, it is possible to downsize the first container as a container for housing the reagent.

(Aspect 2) In the pretreatment device for MALDI described in Aspect 1,

the first container may include a first opening, and a first lid member that opens and closes the first opening.

According to the pretreatment device for MALDI described in Aspect 2, the first lid member can prevent the reagent in the pressurized inside of the first container from scattering to the outside of the first container. Further, the first lid member can prevent foreign matters from entering the first container from the outside of the first container.

(Aspect 3) In the pretreatment device for MALDI described in Aspect 2,

a first insertion hole through which the reagent drawing-out pipe is inserted may be formed in the first lid member.

According to the pretreatment device for MALDI described in Aspect 3, it is possible to draw out the reagent in the first container through the reagent drawing-out pipe inserted through the first insertion hole.

(Aspect 4) The pretreatment device for MALDI described in Aspect 3 may further include a stopper that is attached to the reagent drawing-out pipe, and prevents the reagent drawing-out pipe from coming off from the first insertion hole.

According to the pretreatment device for MALDI described in Aspect 4, by attaching the stopper to an appropriate position of the reagent drawing-out pipe, a tip end position of the reagent drawing-out pipe can be reliably disposed at a position lower than the liquid level of the reagent. Further, the entire first container is lifted by pulling the reagent drawing-out pipe so that the first container can be taken out of the second container.

(Aspect 5) In the pretreatment device for MALDI described in any one of Aspect 1 to Aspect 4,

a vent hole that causes the pressurization space to communicate with the inside of the first container may be formed in the first container.

According to the pretreatment device for MALDI described in Aspect 5, it is possible to introduce the gas in the pressurization space into the first container through the vent hole.

(Aspect 6) In the pretreatment device for MALDI described in any one of Aspect 1 to Aspect 5,

the second container may include a second opening, and a second lid member that opens and closes the second opening, and

the first container may be inserted into the second container through the second opening.

According to the pretreatment device for MALDI described in Aspect 6, the second opening is closed with the second lid member after the first container is housed in the second container through the second opening of the second container, so that the second container can be sealed. By pressurizing the pressurization space in this state, the reagent in the first container can be drawn out.

(Aspect 7) In the pretreatment device for MALDI described in Aspect 6,

a gas inlet that introduces gas into the pressurization space, and a second insertion hole through which the reagent drawing-out pipe is inserted may be formed in the second lid member.

According to the pretreatment device for MALDI described in Aspect 7, the pressurization space can be pressurized by introducing the gas into the sealed second container through the gas inlet. Further, the reagent can be drawn out from the first container housed in the sealed second container through the reagent drawing-out pipe.

What is claimed is:

1. A pretreatment device for MALDI which performs a pretreatment using a reagent for MALDI, comprising:
a first container that houses the reagent;
a second container that houses the first container inside;
a pressurization mechanism that pressurizes a pressurization space formed outside the first container in the second container to pressurize an inside of the first container communicating with the pressurization space; and
a reagent drawing-out pipe that draws out the reagent from the pressurized inside of the first container.

2. The pretreatment device for MALDI according to claim 1, wherein the first container includes a first opening, and a first lid member that opens and closes the first opening.

3. The pretreatment device for MALDI according to claim 2, wherein a first insertion hole through which the reagent drawing-out pipe is inserted is formed in the first lid member.

4. The pretreatment device for MALDI according to claim 3, further comprising:
a stopper that is attached to the reagent drawing-out pipe, and prevents the reagent drawing-out pipe from coming off from the first insertion hole.

5. The pretreatment device for MALDI according to claim 1, wherein a vent hole that causes the pressurization space to communicate with the inside of the first container is formed in the first container.

6. The pretreatment device for MALDI according to claim 1, wherein
the second container includes a second opening, and a second lid member that opens and closes the second opening, and
the first container is inserted into the second container through the second opening.

7. The pretreatment device for MALDI according to claim 6, wherein a gas inlet that introduces gas into the pressurization space, and a second insertion hole through which the reagent drawing-out pipe is inserted are formed in the second lid member.
